(19) United States
(12) Patent Application Publication
(10) Pub. No.: US 2006/0248550 A1
(43) Pub. Date: Nov. 2, 2006

(54) Optical disc drive

(76) Inventors: In-Shuen Lee, Hsinchu (TW); Chih-Chung Hsieh, Hsinchu (TW); Jeng-Wen Huang, Hsinchu (TW); Chun-Jen Tseng, Hsinchu (TW)

Correspondence Address: J C PATENTS, INC., 4 VENTURE, SUITE 250, IRVINE, CA, 92618, US

(21) Appl. No.: 11/198,478

(22) Filed: Aug. 4, 2005

(30) Foreign Application Priority Data
Apr. 29, 2005 (TW) 94113823

(51) Int. Cl. G11B 33/08; G11B 33/14

(52) U.S. Cl. 720/651

(57) ABSTRACT

An optical disc drive for reading the recorded data on an optical disc is provided. The optical disc drive includes a chassis, a turntable and a pickup head. The inner top surface of the chassis has a protruding structure or an escape-prevention component. The turntable is disposed inside the chassis for holding and rotating the optical disc. The protruding structure or the escape-prevention component is located above the optical disc when the optical disc is placed onto the turntable inside the chassis. The movable pickup head is disposed inside the chassis for reading the data recorded on the optical disc. The protruding structure or the escape-prevention component shortens the distance between the top surface of the optical disc and the inner top surface of the chassis. Thus, the optical disc is prevented from escaping from the turntable when the optical disc drive vibrates due to an external force.

### CROSS-REFERENCE TO RELATED APPLICATION

This application claims the priority benefit of Taiwan application serial no. 94113823, filed on Apr. 29, 2005. All disclosure of the Taiwan application is incorporated herein by reference.

### BACKGROUND OF THE INVENTION

1. Field of the Invention

The present invention relates to an optical disc drive. More particularly, the present invention relates to an optical disc drive having an optical disc escape-prevention mechanism.

2. Description of the Related Art

With advantages such as cheap price, portability, large storage capacity, long preservation period, low cost and durability, optical discs have gradually replaced the conventional magnetic storage media to become an indispensable optical storage medium. With the aforesaid advantages and popularity, optical disc drives for reading data recorded on discs have also become a common electronic product.

FIG. 1 is a perspective view of an opened conventional optical disc drive and an optical disc. FIG. 2 is a perspective view showing the opened chassis of FIG. 1. In FIGS. 1 and 2, the optical disc drive 100 includes a chassis 110, a turntable 120, a pickup head 130, a tray 140, a control circuit board 150, flexible cable 160 and a pair of sliding tracks 180. The chassis 110 includes a top chassis 112 and a bottom chassis 114. The turntable 120 and the pickup head 130 are disposed on the tray 140. The control circuit board 150 is disposed on the bottom chassis 114, and the flexible cable 160 connects the turntable 120 and the pickup head 130 to the control circuit board 150.

Before the data recorded in the optical disc 170 is read by the optical disc drive 100, the optical disc 170 is placed on the tray 140 to fit onto the turntable 120; then, the tray 140 is pushed into the chassis 110, guided by the sliding tracks 180. Afterwards, the turntable 120 rotates the optical disc 170, and the pickup head 130 moves along the track-searching path to read the data in the optical disc 170. As the pickup head 130 reads the data from the optical disc 170, the control circuit board 150 controls the movement of the turntable 120 and the pickup head 130 so that data signals captured by the pickup head 130 can be received through the flexible cable 160.

FIG. 3 is a schematic cross-sectional view of the turntable with an optical disc inside the optical disc drive. In FIG. 3, after the optical disc 170 is firmly fitted onto the turntable 120 and pushed into the optical disc drive 100, the optical disc drive 100 can shake or vibrate due to an external force. In the case of a great vibration, the optical disc 170 can escape from the turntable 120. If this occurs, the pickup head 130 can not read the data from the optical disc 170; in the meantime, the optical disc 170 that has escaped from the turntable 120 can cause the tray 140 unable to eject from the chassis 110. Therefore, how to prevent the optical disc from escaping the turntable, during vibrations caused by external forces, is an important issue that needs to be resolved as soon as possible.

### SUMMARY OF THE INVENTION

Accordingly, at least one objective of the present invention is to provide an optical disc drive having a mechanism to prevent an optical disc from escaping a turntable in the optical disc drive during vibrations caused by external forces.

To achieve these and other advantages and in accordance with the purpose of the invention, as embodied and broadly described herein, the invention provides an optical disc drive suitable for reading data from an optical disc. The optical disc drive comprises a chassis, a turntable and a pickup head. The inner top surface of the chassis has a protruding structure. The turntable is disposed inside the chassis for holding and rotating the optical disc. The protruding structure is located above the optical disc when the optical disc is placed on the turntable inside the chassis. The movable pickup head is disposed inside the chassis for reading the data recorded on the optical disc.

The present invention provides an alternative type of optical disc drive for reading the data on an optical disc. The optical disc drive has a design similar to the aforementioned optical disc drive. The only difference is that the optical disc drive uses at least an escape-prevention component disposed on the inner top surface of the chassis instead of using the protruding structure.

According to one embodiment of the present invention, the optical disc has a non-data region located on the inner side of the optical disc. The non-data region of the optical disc is placed on the turntable. Further, the protruding structure or the escape-prevention component is disposed to correspond with the non-data region.

According to one embodiment of the present invention, the optical disc drive can further comprise a tray disposed inside the chassis capable of ejecting from the chassis. The turntable and the pickup head are disposed on the tray. The protruding structure or the escape-prevention component is preferably disposed somewhere away from the path of the turntable as the turntable is ejected from the chassis. In addition, the protruding structure is preferably distributed symmetrically with respect to a line formed by the ejection path of the turntable when the turntable is ejected from the chassis along with the tray. Alternatively, the escape-prevention component is symmetrically disposed on the inner top surface of the chassis with respect to a line formed by the ejection path of the turntable when the turntable is ejected from the chassis along with the tray.

According to one embodiment of the present invention, the protruding structure or the escape-prevention component is U-shaped, correspondingly disposed around the turntable on the inner top surface of the chassis.

According to one embodiment of the present invention, the protruding structure comprises a plurality of round-shaped pads correspondingly disposed around the turntable on the inner top surface of the chassis.

According to one embodiment of the present invention, the escape-prevention component comprises a plurality of round-shaped pads correspondingly disposed around the turntable on the inner top surface of the chassis.

According to one embodiment of the present invention, the optical disc drive can further comprise a control circuit board and a flexible cable. The control circuit board is disposed inside the chassis and the flexible cable connects the pickup head and the turntable with the control circuit board.

According to one embodiment of the present invention, the distance between the optical disc and the protruding structure or the escape-prevention component is preferably less than or equal to 0.9 mm.

According to one embodiment of the present invention, the escape-prevention component is a cushioning pad, for example.

According to the present invention, the optical disc drive has a protruding structure or at least an escape-prevention component disposed on the inner top surface of the chassis to shorten the distance between the optical disc and the inner top surface of the optical disc drive. In this way, even when the optical disc drive shakes or vibrates due to an external force, the optical disc does not easily dislodge from the turntable. Consequently, the pickup head inside the optical disc drive can read the recorded data on the optical disc uninterruptedly.

It is to be understood that both the foregoing general description and the following detailed description are exemplary, and are intended to provide further explanations of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of an opened conventional optical disc drive and an optical disc.

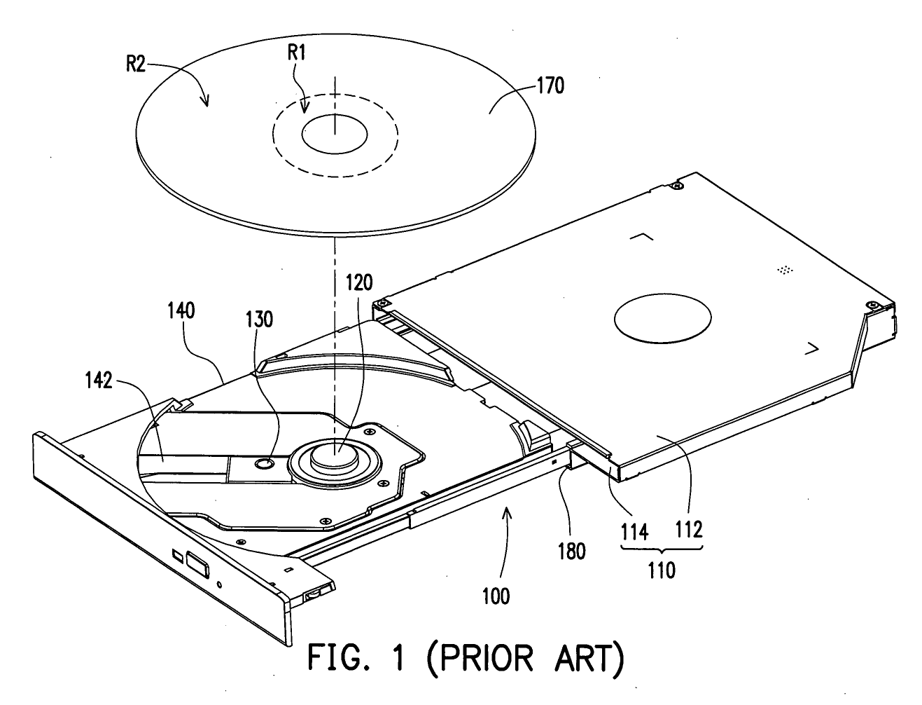

FIG. 2 is a perspective view showing the opened chassis of FIG. 1.

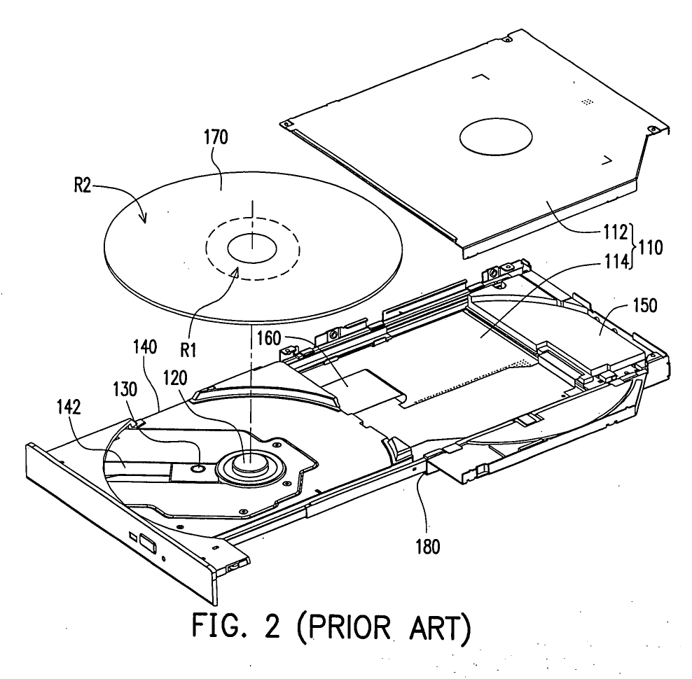

FIG. 3 is a schematic cross-sectional view of a turntable of the optical disc drive of FIG. 1 when inserted with an optical disc.

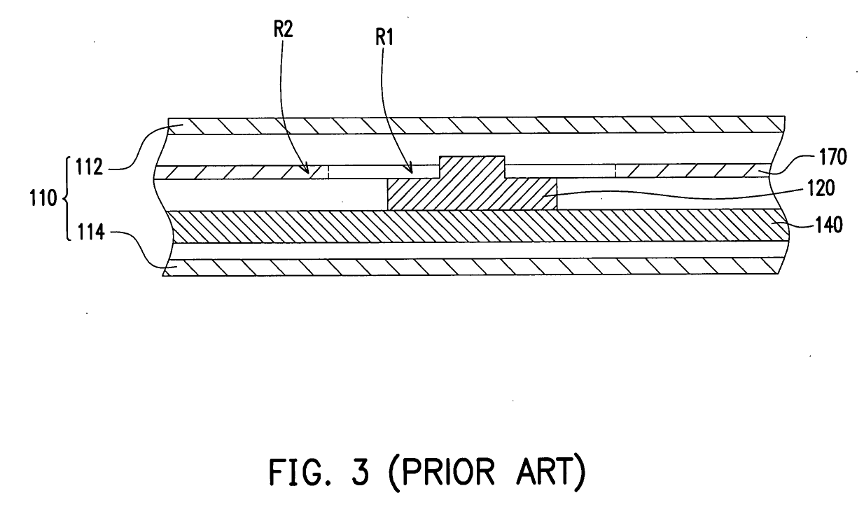

FIG. 4 is a perspective view of an opened optical disc drive and an optical disc according to a first embodiment of the present invention.

FIG. 5 is a perspective view showing the opened chassis of FIG. 4.

FIG. 6 is a schematic cross-sectional view of a turntable of the optical disc drive of FIG. 4 when inserted with an optical disc.

FIG. 7 is a perspective view showing the inner top surface of the chassis of an optical disc drive according to a second embodiment of the present invention.

FIG. 8 is a perspective view showing the inner top surface of the chassis of an optical disc drive according to a third embodiment of the present invention.

FIG. 9 is a perspective view showing the inner top surface of the chassis of an optical disc drive according to a fourth embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

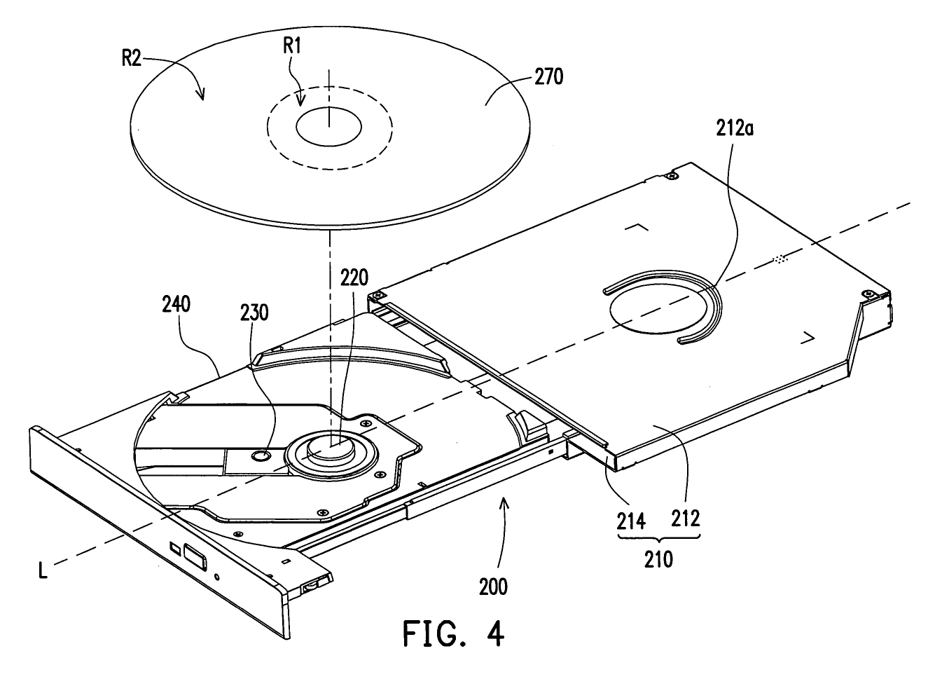

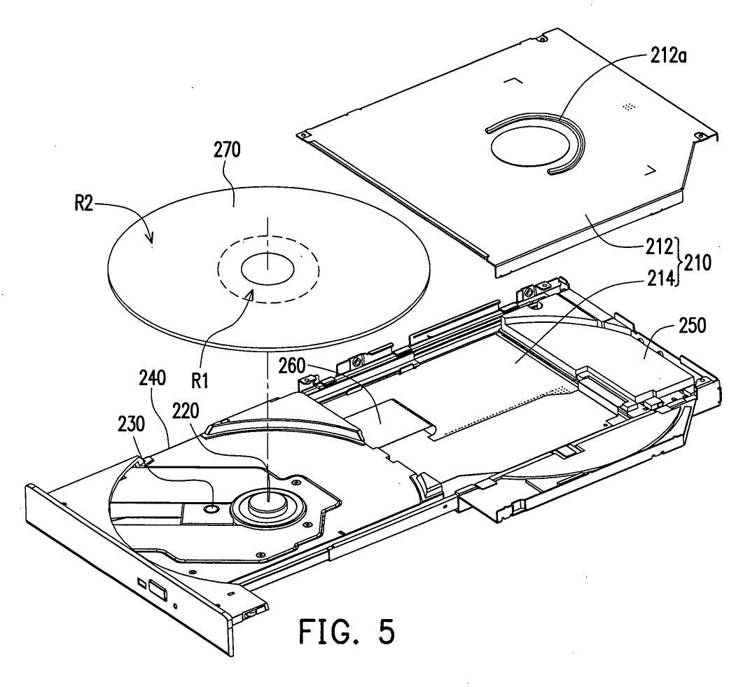

FIG. 4 is a perspective view of an opened optical disc drive and an optical disc according to a first embodiment of the present invention. FIG. 5 is a perspective view showing the opened chassis of FIG. 4. In FIGS. 4 and 5, an optical disc drive 200 mainly includes a chassis 210, a turntable 220 and a pickup head 230. The chassis 210 includes a top chassis 212 and a bottom chassis 214, for example. The inner surface of the top chassis 212 (the inner top surface of the chassis 210) has a protruding structure 212a. The turntable 220 is disposed inside the chassis 210 for holding and rotating an optical disc 270. When the optical disc 270 is placed on the turntable 220 inside the chassis 210, the protruding structure 212a is located above the optical disc 270. The pickup head 230 is a movable element disposed inside the chassis 210 for reading recorded data from the optical disc 270.

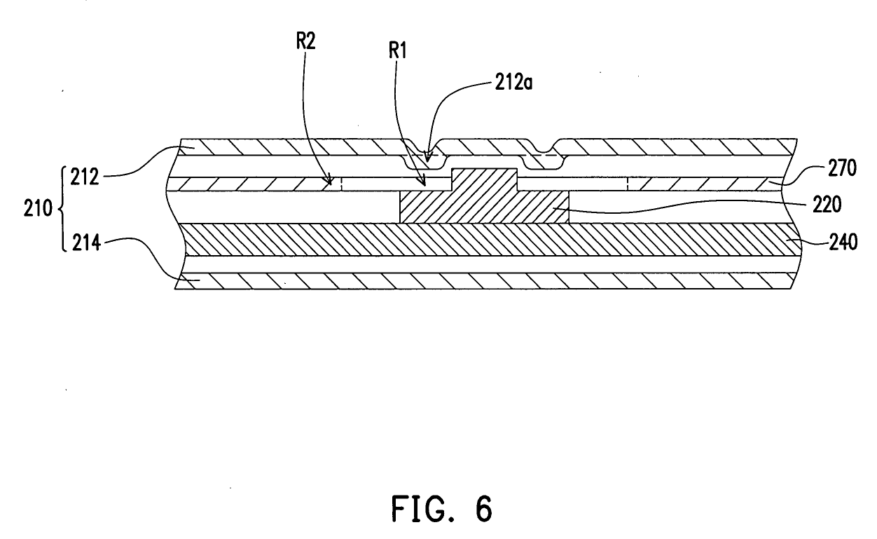

FIG. 6 is a schematic cross-sectional view of a turntable of the optical disc drive of FIG. 4 when inserted with an optical disc. In FIG. 6, the protruding structure 212a locates on the inner top surface (for example, the inner surface of the top chassis 212 in the present embodiment) of the chassis 210. Thus, the distance between the inner top surface of the chassis 210 and the top surface of the optical disc 270 is smaller than that of a conventional design. With the reduced distance between the inner top surface of the chassis 210 and the top surface of the optical disc 270 made possible by the protruding structure 212a, the optical disc 270 would not easily escape from the turntable 220 when shaking or vibrating due to an external force. Therefore, the optical disc drive 200 can still read recorded data from the optical disc 270 without interruption.

In addition, when the optical disc 270 is on the turntable 220 inside the chassis 210 of the optical disc drive 200, the distance between the top surface of the optical disc 270 and the protruding structure 212a is preferably smaller than the thickness of the optical disc 270 (for example smaller than or equal to 0.9 mm.) The protruding structure 212a can be formed by stamping the top chassis 212 in a punching operation. Obviously, the protruding structure 212a on the top chassis 212 can be formed by other methods.

In FIGS. 5 and 6, the optical disc 270 has a non-data region R1 located on the inner side of the optical disc 270, and a data region R2 encircling the non-data region R1. The area that rests on the turntable 220 in the optical disc 270 is the non-data region R1. Furthermore, the protruding structure 212a is preferable disposed within the corresponding non-data region R1 to prevent the protruding structure 212a from causing any damage to the data region R2 of the optical disc 270. Moreover, the protruding structure 212a can enhance the strength of the top chassis 212.

The optical disc drive 200 can further include a tray 240 disposed inside the chassis 210 for ejecting from the chassis 210. The turntable 220 and the pickup head 230 are disposed on the tray 240.

In FIG. 4, the protruding structure 212a can be in a U-shape, correspondingly laying around the turntable 220. Because the upper surface of the turntable 220 is typically made higher than the surface of the optical disc 270, the turntable 220 possibly can hit the protruding structure 212a when the turntable 220 is ejected from the chassis 210. Therefore, the protruding structure 212a is preferably disposed in a location away from the moving path L where the turntable 220 is ejected from the chassis 210 along with the tray 240. The moving path L refers to the central line of the turntable 220 as the tray 240 moves into or out of the chassis 210. Since the protruding structure 212a is disposed in a location away from the pathway L of the turntable 220, the turntable 220 would not interfere with the protruding structure 212a on the inner surface of the top chassis 212. Hence, clashes between the turntable 220 and the protruding structure 212a are prevented.

In addition, the protruding structure 212a can be disposed symmetrically according to the moving path L of the turntable 220.

The optical disc drive 200 can also include a control circuit board 250 and a flexible cable 260. The control circuit board 250 is disposed on the bottom chassis 214 and the flexible cable 260 connects the pickup head 230 and the turntable 220 with the control circuit board 250. When the pickup head 230 reads data on the optical disc 270, the control circuit board 250 controls the actions of the turntable 220 and the pickup head 230 and reads the data signals captured by the pickup head 230 through the flexible cable 260.

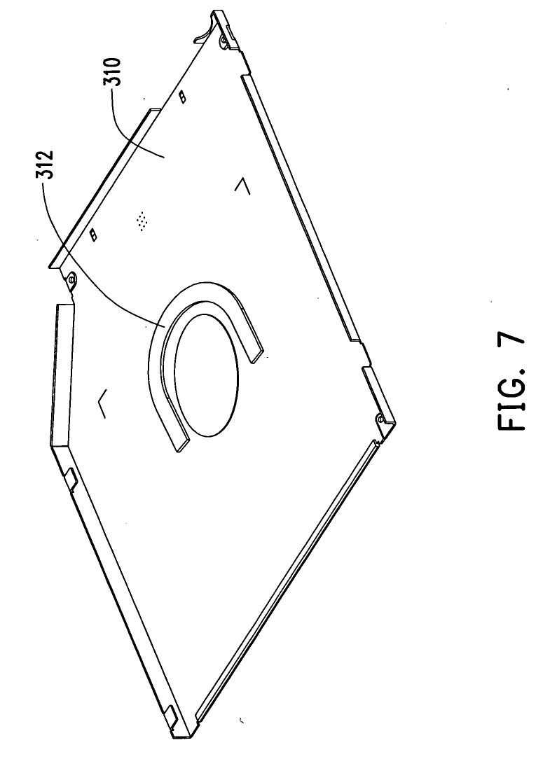

FIG. 7 is a perspective view showing the inner top surface of the chassis inside an optical disc drive according to a second embodiment of the present invention. In FIG. 7, one difference between the present embodiment and the first embodiment is that the optical disc drive of the present invention has at least an escape-prevention component 312, instead of the protruding structure 212a, disposed on the inner top surface of the chassis 310. Since the method of disposing the escape-prevention component 312 and deciding the distance between the escape-prevention component 312 and the optical disc is identical to the method used in the protruding structure 212a, a detailed description is omitted. Additionally, the escape-prevention component is a cushioning pad preferably fabricated from rubber or a soft material.

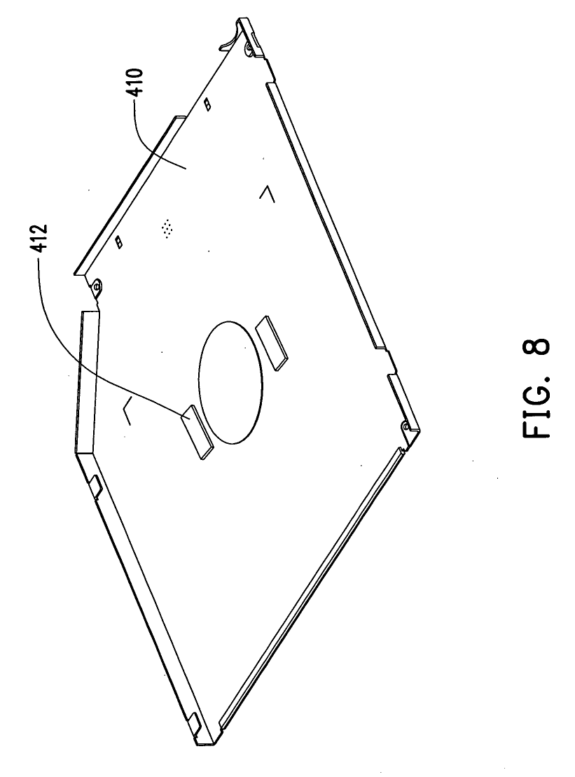

FIG. 8 is a perspective view showing the inner top surface of the chassis inside an optical disc drive according to a third embodiment of the present invention. In FIG. 8, one major difference between the second embodiment and the third embodiment is that the escape-prevention component 412 of the third embodiment includes two rectangular pieces disposed on the inner top surface of the chassis 410 while the escape-prevention component 312 of the second embodiment includes a single U-shaped piece.

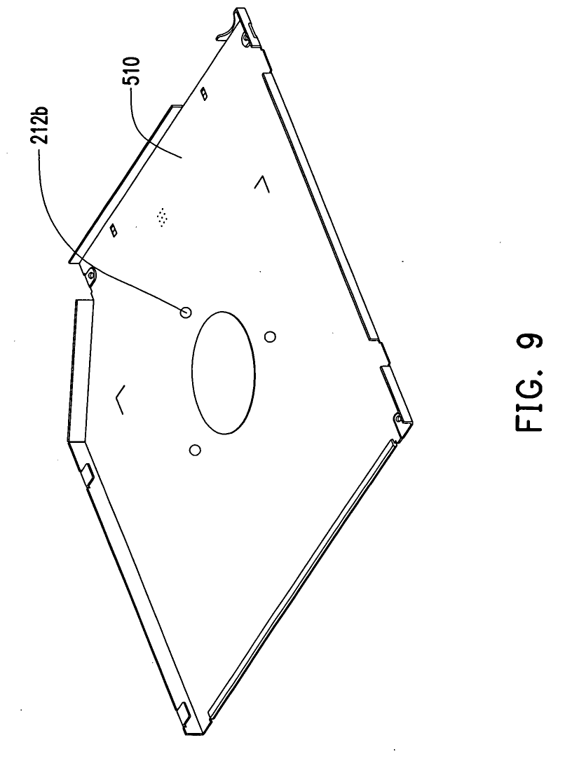

FIG. 9 is a perspective view showing the inner top surface of the chassis inside an optical disc drive according to a fourth embodiment of the present invention. In FIG. 9, the fourth embodiment is very similar to the optical disc drive 200 of the first embodiment. The only difference is that the protruding structure 212b of the fourth embodiment includes a plurality of round-shaped pads correspondingly disposed around the turntable 220 on the inner top surface of the chassis 510 while the protruding structure 212a of the first embodiment is U-shaped. Furthermore, the protruding structure 212b can be substituted with an escape-prevention component including a plurality of round-shaped pads disposed on the inner top surface (not shown) of the chassis.

In summary, according to the present invention, the optical disc drive has a protruding structure or an escape-prevention component disposed on the inner top surface of the chassis to reduce the distance between the top surface of the optical disc and the inner top surface of the chassis. Therefore, even when the optical disc drive shakes and vibrates due to an external force, the extremely small distance can prevent the optical disc from dislodging from the turntable. Consequently, the pickup head inside the optical disc drive is able to read the recorded data on the optical disc uninterruptedly.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical disc drive for reading recorded data on an optical disc, the optical disc drive comprising:
a chassis having a protruding structure disposed on an inner top surface of the chassis;
a turntable disposed inside the chassis, wherein the turntable is suitable for holding and rotating the optical disc which has a non-data region located on the inner side of the optical disc; and
a movable pickup head disposed inside the chassis for reading the recorded data on the optical disc,
wherein the protruding structure comprises a plurality of round-shaped pads correspondingly disposed above the non-data region of the optical disc when the optical disc is placed on the turntable inside the chassis.

2. The optical disc drive of claim 1, wherein the non-data region of the optical disc rests on the turntable.

3. The optical disc drive of claim 1, further comprising a tray disposed inside the chassis and suitable for ejecting from the chassis, and the turntable and the pickup head are disposed on the tray.

4. The optical disc drive of claim 1, wherein the protruding structure is disposed in a location away from the path traversed by the turntable when the turntable is ejected from the chassis.

5. The optical disc drive of claim 1, wherein the protruding structure is symmetrically positioned with respect to a line formed by the path traversed by the turntable as the turntable is ejected from the chassis.

6. The optical disc drive of claim 1, wherein the disc drive further comprises:
a control circuit board disposed inside the chassis; and
a flexible cable connecting the pickup head and the turntable with the control circuit board.

7. The optical disc drive of claim 1, wherein the distance between the top surface of the optical disc and the protruding structure is smaller than or equal to 0.9 mm.

8. An optical disc drive for reading the recorded data from an optical disc, the optical disc drive comprising:
a chassis;
at least an escape-prevention component disposed on the inner top surface of the chassis;
a turntable disposed inside the chassis, wherein the turntable is suitable for holding and rotating the optical disc which has a non-data region located on the inner side of the optical disc; and
a movable pickup head disposed inside the chassis for reading the recorded data on the optical disc,
wherein the escape-prevention component comprises cushioning pads located above the non-data region of the optical disc when the optical disc is placed onto the turntable inside the chassis.

9. The optical disc drive of claim 8, wherein the non-data region of the optical disc rests on the turntable.

10. The optical disc drive of claim 8, further comprising a tray disposed inside the chassis and suitable for ejecting from the chassis, and the turntable and the pickup head are disposed on the tray.

11. The optical disc drive of claim 8, wherein the escape-prevention component is disposed in a location away from the path traversed by the turntable as the turntable is ejected from the chassis.

12. The optical disc drive of claim 8, wherein the escape-prevention component is symmetrically positioned with respect to a line formed by the path traversed by the turntable as the turntable is ejected from the chassis.

13. The optical disc drive of claim 8, wherein the disc drive further comprises:
a control circuit board disposed inside the chassis; and
a flexible cable connecting the pickup head and the turntable with the control circuit board.

14. The optical disc drive of claim 8, wherein the distance between the top surface of the optical disc and the escape-prevention component is smaller than or equal to 0.9 mm.

15. An optical disc drive for reading the recorded data from an optical disc, the optical disc drive comprising:
a chassis;
at least an escape-prevention component disposed on the inner top surface of the chassis;
a turntable disposed inside the chassis, wherein the turntable is suitable for holding and rotating the optical disc which has a non-data region located on the inner side of the optical disc; and
a movable pickup head disposed inside the chassis for reading the recorded data on the optical disc,
wherein the escape-prevention component comprises an U-shaped cushioning pad located above the non-data region of the optical disc when the optical disc is placed onto the turntable inside the chassis.

16. The optical disc drive of claim 15, wherein the non-data region of the optical disc rests on the turntable.

17. The optical disc drive of claim 15, further comprising a tray disposed inside the chassis and suitable for ejecting from the chassis, and the turntable and the pickup head are disposed on the tray.

18. The optical disc drive of claim 15, wherein the escape-prevention component is disposed in a location away from the path traversed by the turntable as the turntable is ejected from the chassis.

19. The optical disc drive of claim 15, wherein the escape-prevention component is symmetrically positioned with respect to a line formed by the path traversed by the turntable as the turntable is ejected from the chassis.

20. The optical disc drive of claim 15, wherein the distance between the top surface of the optical disc and the escape-prevention component is smaller than or equal to 0.9 mm.
